(19) United States
(12) Patent Application Publication
(10) Pub. No.: US 2026/0015789 A1
(43) Pub. Date: Jan. 15, 2026

(54) FLEXIBLE WALL COVERING WITH VIRUCIDAL COATING AND METHOD FOR MANUFACTURE THEREOF

(71) Applicant: GRANDECO WALLFASHION GROUP - BELGIUM NV, Tielt (BE)

(72) Inventors: Patrick MOLEMANS, Tielt (BE); Herman VAN DER PLAETSEN, Tielt (BE)

(21) Appl. No.: 18/997,121

(22) PCT Filed: Jul. 24, 2023
(86) PCT No.: PCT/IB2023/057499

§ 371 Date: Jan. 20, 2025

(30) Foreign Application Priority Data
Jul. 25, 2022 (BE) BE2022/5590

(51) Int. Cl. D06N 7/00; A01N 25/34; A01N 29/02; A01N 47/40; A01N 55/00; A01P 1/00; D06M 10/00; D06M 10/08; D06M 16/00; D06M 23/02; D06M 23/06; D06M 23/16

(52) U.S. Cl. CPC D06N 7/0002; A01N 25/34; A01N 29/02; A01N 47/40; A01N 55/00; A01P 1/00; D06M 10/001; D06M 10/08; D06M 16/00; D06M 23/02; D06M 23/06; D06M 23/16; D06N 2203/048; D06N 2203/068

(57) ABSTRACT

The present invention relates to a flexible wall covering with virucidal coating. preferably wallpaper, comprising: a substrate layer of carrier material, the substrate layer comprising and preferably being a nonwoven, and the substrate layer having a surface density of at least 50 g/m² and at most 180 g/m²; a coating layer on the carrier material, the coating layer comprising a vinyl composition and preferably comprising polyvinyl chloride (PVC); and a top layer on the coating layer, the top layer being applied via a printing process; the top layer comprising a virucidal coating, wherein the virucidal coating comprises a mixture of a fluoropolymer, an isocyanate, and a methoxysilane. The invention also relates to a method and a flexible wall covering obtained according to the method.

### TECHNICAL FIELD

In a first and second aspect, the invention relates to a flexible wall covering with virucidal coating.

In a third aspect, the invention also relates to a method for manufacturing a flexible wall covering with virucidal coating.

In a fourth aspect, the invention also relates to a flexible wall covering with virucidal coating manufactured by means of a method according to the third aspect.

### PRIOR ART

Such a device is known, inter alia, from EP3020761 (EP '761). EP '761 describes an antiviral composition, an antiviral wallpaper and a method for manufacturing antiviral wallpaper. The antiviral composition comprises a PVC-based resin and a surfactant component based on sulfuric acid. The antiviral composition is applied to a surface by melting.

Also known is the method from US20130267652 (US '652). US '652 relates to a method of coating a surface first with a siloxane oligomer and then with a solution containing a C4-C24 alkyl, alkenyl or alkynyl group substituted with an F, Cl Br or I. The hydrophobic coating can be placed on the surface of materials such as glass, ceramics, wood, leather, metals, etc.

WO2021234162 describes a coating comprising a first polysiloxane or polytitanoxane network consisting of inorganic nanoparticles connected to a second polymer network. The coating is applied to glass or steel by spraying.

The virucidal properties of this known device decrease with the application of an ink, are difficult to apply and/or require high amounts to be effective for a long time. The present invention aims to solve at least some of the above problems or drawbacks.

### SUMMARY OF THE INVENTION

In a first aspect, the present invention relates to a flexible wall covering according to claim 1. The wall covering has virucidal properties. A top layer on the top of the wall covering comprises a disinfectant mixture that forms a virucidal coating. This mixture kills viruses and microorganisms in a physical way and not by a chemical or biochemical reaction. Thus, no resistance can develop. The top layer is very strong, durable and effective for a long time. Preferred forms of the flexible wall covering are shown in claims 2 and 3.

In a second aspect, the present invention relates to a flexible wall covering according to claim 4. The virucidal coating can also be printed directly onto nonwoven or paper carriers if the surface is smooth enough and allows adhesion.

In a third aspect, the present invention relates to a method according to claim 5. One of the advantages of this method is that a coating layer with a vinyl composition on a nonwoven substrate provides a good surface on which to apply the mixture. The polarity distribution of the vinyl composition ensures good adhesion of the top layer as well as efficient use of the mixture. Preferred forms of the method are described in the dependent claims 6 to 14.

In a fourth aspect, the present invention relates to a flexible wall covering according to claim 15. This flexible wall covering kills viruses and microorganisms that come into its vicinity quickly and for a long time.

### DESCRIPTION OF THE FIGURES

FIG. 1 shows a schematic representation of a coating process according to an embodiment of the present invention.

FIG. 2 shows a schematic representation of a printing process according to an embodiment of the present invention.

### DETAILED DESCRIPTION

Unless otherwise defined, all terms used in the description of the invention, including technical and scientific terms, have the meaning as commonly understood by a person skilled in the art to which the invention pertains. For a better understanding of the description of the invention, the following terms are explained explicitly.

In this document, “a” and “the” refer to both the singular and the plural, unless the context presupposes otherwise. For example, “a segment” means one or more segments.

Quoting numeric intervals by the endpoints includes all integers, fractions, and/or real numbers between the endpoints, including those endpoints.

The term “embossing” is a term known in the prior art and refers in the present invention to the application of a relief in a coating layer and/or top layer using a printing process. This typically involves pressing a specific template into the coating layer and/or top layer, with or without the use of heat to enhance the printing process.

The term “polymer” as used herein includes, but is not limited to, homopolymers; copolymers, such as, for example, block, graft, random and alternating copolymers, terpolymers, etc.; and/or mixtures and/or modifications thereof. In addition, unless otherwise specifically limited, the term “polymer” includes all possible geometric configurations of the material. These configurations include, but are not limited to, isotactic, syndiotactic, and random symmetries. Examples of polymers include, but are not limited to, polyethylene (PE), polypropylene (PP), polystyrene (PS), polyethylene terephthalate (PET), polyvinyl chloride (PVC), etc.

The term “color” as used herein means any possible color and includes white, black, red, orange, yellow, green, blue, indigo, violet, brown, and/or any other possible color or combination of colors.

The term “wall decoration” refers to any type of wall decoration as known in the art, such as wallpaper, decorative wall panels, etc. The wall decoration is preferably wallpaper.

The term “polyvinyl chloride” as used in the present invention includes not only the polymer polyvinyl chloride, but also variants of polyvinyl chloride, such as polyvinylidene chloride, polyvinyl acetate, polyacrylate, polymethacrylate and/or combinations thereof. Preferably, the term “polyvinyl chloride” refers to the polymer polyvinyl chloride. The polyvinyl chloride may take any form known in the art. Preferably, the composition and/or the at least one printed layer comprises powdered polyvinyl chloride. During the fixing of the at least one printed layer on the coating layer—because both the composition of the coating layer and the at least one printed layer comprise polyvinyl chloride—these polyvinyl chlorides interact with each other in the form of a physical bond, as a result of which the at least one printed layer is better fixed, i.e. immobilized on the coating layer. Studies have shown that due to this interaction, color variations between wall decorations of the same type, produced in different batches, can be reduced to a minimum.

The expression “weight percent,” “weight percentage,” “% w” or “w %,” here and throughout the specification, unless otherwise defined, refers to the relative weight of the respective component based on the total weight of a composition.

In a first aspect, the invention relates to a flexible wall covering with virucidal coating, preferably wallpaper. According to an embodiment, the wall decoration has a total surface density of at least 150 g/m², preferably at least 250 g/m², more preferably at least 425 g/m², and at most 700 g/m², preferably at most 600 g/m², more preferably at most 525 g/m².

The wall covering has virucidal properties. A top layer on the top of the wall covering comprises a disinfectant mixture. This mixture kills viruses and microorganisms in a physical way and not by a chemical or biochemical reaction. Thus, no resistance can develop. The top layer is very strong, durable and effective for a long time.

According to an embodiment, the flexible wall covering comprises a substrate layer of carrier material, the substrate layer comprising and preferably being a nonwoven, and the substrate layer having a surface density of at least 50 g/m², preferably at least 65 g/m², more preferably at least 70 g/m², and at most 180 g/m², preferably at most 120 g/m², more preferably at most 100 g/m². The substrate layer comprises a nonwoven (and is preferably a nonwoven with no additional layers, unless there are any attachment layers), and acts as a support structure to which a coating layer is typically applied during production. Because the substrate layer has a surface density of at least 50 g/m², preferably at least 65 g/m², more preferably at least 70 g/m², and at most 180 g/m², preferably at most 120 g/m², more preferably at most 100 g/m², the substrate layer is strong enough to support the coating layer and top layer. The substrate layer is also not too heavy to make it difficult to install.

According to an embodiment, the flexible wall covering comprises a coating layer on the carrier material, the coating layer comprising a vinyl composition and preferably comprising polyvinyl chloride (PVC). A typical vinyl composition for a coating layer consists of a PVC (polyvinyl chloride) resin, an extender PVC resin, filler, heat stabilizer, a plasticizer, blowing agent, dispersant, pigments and optionally a viscosity regulator. However, it should be noted that not every one of these components is critical or essential. Some can be omitted depending on the requirements for the final product (both qualitative requirements and specific physical/chemical characteristics). A number of these components affect the polarity at the surface of the coating layer, where the top layer is applied. Surprisingly, the applicant noted that the presence of a vinyl composition further enhanced the virucidal properties of the virucidal coating.

According to an embodiment, the flexible wall covering comprises a top layer on the coating layer, the top layer being applied via a printing process. Because the top layer is applied via a printing process, it can be applied evenly. The virucidal coating can be properly dosed in order to apply the right amount in a targeted manner.

According to an embodiment, the top layer comprises a virucidal coating and optionally inks, wherein the virucidal coating comprises a mixture of an isocyanate, a methoxysilane and optionally of a hydrophobic polymer, for example a fluoropolymer. According to an embodiment, the top layer comprises a virucidal coating and inks, wherein the virucidal coating comprises a mixture of a fluoropolymer, an isocyanate, and a methoxysilane. According to an embodiment, the ink is a water-based ink.

A methoxysilane refers to a molecule where at least one methoxy group is bound to a silicon, preferably 3 methoxy groups. According to an embodiment, the methoxysilane is a component according to R₁—Si(OR₂)₃, where R₁ is an alkylene or alkyl, optionally substituted with a halogen, nitrogen group or phosphorus group; and wherein R₂ is methyl. According to an embodiment, the mixture comprises a methoxysilane from Table 1. According to an embodiment, the mixture comprises one or more molecules from Table 1. According to an embodiment, the mixture comprises three molecules from Table 1.

TABLE 1
Examples of methoxysilanes

| No. | Name | Formula |
|---|---|---|
| 1 | vinyltrimethoxysilane | 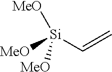 |
| 2 | 3-aminopropyltrimethoxysilane | 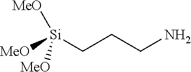 |
| 3 | 3-mercaptopropyltrimethoxysilane | 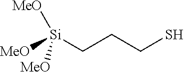 |
| 4 | 3-chloropropyltrimethoxysilane | 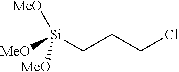 |
| 5 | 3-(trimethoxysilyl)propyl methacrylate | 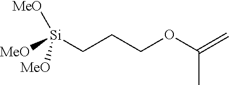 |
| 6 | dimethyloctadecyl[3- (trimethoxysilyl)propyl]ammonium chloride | 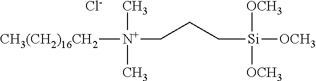 |
| 7 | 3-azidopropyltrimethoxysilane | 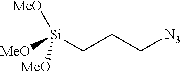 |
| 8 | γ-glycidoxypropyltrimethoxysilane | 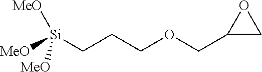 |

A fluoropolymer is understood to mean a molecule with a molecular weight of at least 250 g/mol and this molecule contains at least 3 fluorine atoms per mole. The fluoropolymer is preferably built up from at least 3, preferably at least 10 monomers, the monomer comprising at least 1 fluorine and 1 carbon atom. According to an embodiment, the fluoropolymer is: polytetrafluoroethylene, perfluoroalkoxy polymer resin, fluorinated ethylene propylene, trifluoroethanol, ethylene-tetrafluoroethylene copolymer, polyvinylidene fluoride (PVdF), or fluoroethylene vinyl ether (FEVE). According to an embodiment, the fluoropolymer is: PVdF or FEVE. According to an embodiment, the fluoropolymer is FEVE.

An isocyanate is understood to mean a molecule in which at least one nitrogen is double-bonded to a carbon, where this carbon is also double-bonded to an oxygen. According to an embodiment, the isocyanate is a diisocyanate or a polyisocyanate. According to an embodiment, the isocyanate is a diisocyanate or a polyisocyanate with an aliphatic linkage between the isocyanate groups, such as, for example, hexamethylene diisocyanate or isophorone diisocyanate.

The applicant noticed that the vinyl composition in the coating layer improved the efficiency of the virucidal coating. This coating layer comprises polar and apolar zones. The polar portion is on the outside of the coating, and its non-polar portion toward the bulk of the coating. This shows that the degree of polarity at the surface of the vinyl layer largely determines the flow out of the virucidal coating. In places with a low surface polarity of the coating layer, insufficient wetting by the virucidal coating is achieved. Since the layer underneath is more non-polar, the virucidal coating will not penetrate deeply into the coating layer and the substrate.

According to an embodiment, the mixture forms a first polysiloxane network comprising inorganic nanoparticles linked to a second polymer network. According to a further embodiment, the first polysiloxane network of the virucidal coating comprises one or more quaternary ammonium compounds. Without wishing to be bound by scientific theory, the quaternary ammonium cation can attract the negatively charged virus particles. The carbon chain present on the quaternary ammonium cation can damage the virus particle. The protective layer around the genetic material of a virus is particularly susceptible to damage.

According to a preferred embodiment, the top layer comprises 0.5-20 g of virucidal coating per m², preferably 2-10 g, more preferably 2-5 g.

Because the top layer comprises 0.5-20 g virucidal coating per m², there is sufficient virucidal coating present to kill the viruses sufficiently quickly. The amount of virucidal coating is measured after drying. According to an embodiment, the top layer comprises 2-15 g, 10-15 g, 1-3 g, 1-5 g or 4-10 g virucidal coating.

According to a preferred embodiment, the vinyl composition comprises the following components: polyvinyl chloride (PVC); polyurethane (PU); pigments, preferably at least one pigment; and one or more fillers, preferably one or more of bentonite, calcium carbonate, magnesium carbonate, talc, kaolin, silica, alumina, magnesium hydroxide, clay and/or combinations thereof, wherein the vinyl composition comprises 1-50 weight percent fillers.

According to an embodiment, the vinyl composition comprises polyvinyl chloride (PVC) and polyurethane (PU), each comprising at least 10 w % of the vinyl composition, more preferably each at least 20 w %. According to an embodiment, the vinyl composition comprises polyvinyl chloride (PVC) and polyurethane (PU), the ratio of PU over PVC being between 5:1 and 1:5, more preferably between 1:1 and 1:5.

According to an embodiment, the vinyl composition comprises one or more fillers from one or more of the following list: bentonite, calcium carbonate, magnesium carbonate, talc, kaolin, silica, aluminum, magnesium hydroxide, clay and/or combinations thereof. In a further preferred embodiment, the vinyl composition comprises 1-50 weight percent fillers, preferably 5-45 weight percent fillers, more preferably a maximum of 10-40 weight percent fillers, and most preferably 15-35 weight percent fillers. The applicant notes that the presence of fillers in the coating layer causes local peaks in polarity, allowing the top layer to flow out from there. Compared to other fillers, the above choices of fillers had a reduced disturbing effect on the polarity (fewer and less strong local peaks).

In a second aspect, the invention relates to a flexible wall covering with virucidal coating, preferably wallpaper, comprising: a substrate layer of carrier material, the substrate layer comprising and preferably being a nonwoven, and the substrate layer having a coefficient of friction of at most 0.4, preferably 0.05-0.3; a top layer on the substrate layer, the top layer being applied via a printing process; wherein the top layer comprises a virucidal coating and optionally inks, wherein the virucidal coating comprises a mixture of an isocyanate, a methoxysilane. The coefficient of friction is measured according to ISO 8295:1995 by moving one piece of the substrate layer against another piece of the substrate layer. The coefficient of friction is defined by the frictional force over normal force. The virucidal coating can be printed directly onto nonwoven or paper carrier if the surface is smooth enough and allows adhesion.

In a third aspect, the invention relates to a method for manufacturing a flexible wall covering with virucidal coating, preferably a wallpaper.

According to an embodiment, the method comprises the step of providing a substrate layer with carrier material, the substrate layer comprising and preferably being a nonwoven, and the substrate layer having a surface density of at least 50 g/m², preferably at least 65 g/m², more preferably at least 70 g/m², and at most 180 g/m², preferably at most 120 g/m², more preferably at most 100 g/m². Because the substrate layer has a surface density of at least 50 g/m² and at most 180 g/m², the substrate layer is strong enough to support the coating layer and top layer. The substrate layer is also not too heavy to make it difficult to install.

According to an embodiment, the method comprises the step of applying a coating layer to the substrate layer, the substrate layer comprising and preferably being a nonwoven. Surprisingly, the applicant noted that the presence of a vinyl composition further enhanced the virucidal properties of the virucidal coating.

According to an embodiment, the coating layer is provided with a minimum surface density of 100 g/m², preferably at least 150 g/m²; and wherein the coating layer preferably has a maximum surface density of 260 g/m², more preferably of 200 g/m².

According to an embodiment, the method comprises the step of applying at least one top layer to the coating layer via a printing process.

According to an embodiment, the method comprises the step of drying the top layer. According to an embodiment, the top layer is dried in an oven with IR lamps with a total electrical power of 50-500 kW for 1-100 minutes, preferably 200-300 kW and for 5-50 minutes. According to an embodiment, the substrate layer is passed through the oven at a speed between 50 meters per minute (mpm) and 100 mpm.

According to an embodiment, the method comprises the step of providing a relief by embossing in the coating layer, preferably prior to applying the at least one top layer.

In an embodiment, the top layer comprises a virucidal coating and optionally inks, and wherein the virucidal coating is obtained by mixing an isocyanate, a methoxysilane and optionally a fluoropolymer. In an embodiment, the top layer comprises a virucidal coating and inks and wherein the virucidal coating is obtained by mixing a fluoropolymer, an isocyanate and a methoxysilane.

One of the advantages of this method is that a coating layer with a vinyl composition on a nonwoven substrate provides a good surface on which to apply the mixture. The polarity distribution of the vinyl composition ensures good adhesion of the top layer as well as efficient use of the mixture. The amount of mixture required is therefore lower compared to other surfaces.

In an embodiment, 1-15 w % fluoropolymer, 1-10 w % isocyanate and 0.2-15 w % methoxysilane are mixed with at least one solvent to obtain the virucidal coating. In an embodiment, 1-15 w % fluoropolymer, 1-10 w % isocyanate and 2-15 w % methoxysilane are mixed with 0-10 w % solvent and an amount of water, bringing the total weight percent to 100%, to obtain the virucidal coating. According to an embodiment, the mixture comprises 50-90 w % water, preferably 70-85 w %.

In an embodiment, the blend comprises 3-12 w % fluoropolymer, 10-70 w % polyisocyanate, 0-0.2 w % diisocyanate, 0.2-3 w % 3-chloropropyltrimethoxysilane, and 0.2-5 w % dimethyloctadecyl[3-(trimethoxysilyl)propyl]ammonium chloride in 50-80 w % water. In an embodiment, the mixture comprises 3-5 w % fluoropolymer, 15-30 w % polyisocyanate and 0.5-3 w % methoxysilane in 50-80 w % water.

In a preferred embodiment, the top layer is provided via a roll coating technique. This is preferably done on the basis of at least one, preferably at least two, gravure cylinders. This technique ensures a qualitatively superior product, because the applied top layer can be applied very evenly, and intervention can be made quickly if necessary (if the top layer is detected to be too thin, this can be quickly adjusted).

According to a further embodiment, the side of the substrate layer where the coating layer is provided lies against the first gravure cylinder and the second gravure cylinder provides a pressure on the substrate layer and the provided coating layer between 0.2 and 2.5 bar, preferably 1 and 2 bar. This pressure is ideal for applying the virucidal coating. Since the amount applied is important, the pressure should not be too high. Because the three-dimensional structure of the virucidal coating is important, the pressure should not be too high.

According to a further embodiment, the virucidal coating is applied to 1000-8000 rectangular cells per cm² surface of the first gravure cylinder, the rectangular cells being formed by grid-shaped grooves in the surface of the first gravure cylinder. Preferably, the jacket of the first gravure cylinder comprises 2000-3500 rectangular cells per cm² surface. This amount of cells is optimal to apply the virucidal coating to the coating layer with high efficiency.

According to a further embodiment, the distance between the grooves running in the same direction is 50-500 μm, and the grooves are 20-100 μm deep. These distances between the grooves are ideal for applying virucidal coating to sufficiently large surfaces. According to a further embodiment, the distance between the grooves running in the same direction is 200-300 um, and the grooves are 45-60 μm deep.

According to an embodiment, the mixture is contained in a reservoir below the center of the first cylinder and the shortest distance between the liquid level of the mixture and the center axis of the first cylinder is less than the radius of the first cylinder.

According to an embodiment, the inks and the mixture are applied to the coating layer using gravure cylinders. According to an embodiment, the inks are applied with one or more gravure cylinders and then the mixture is applied with a gravure cylinder. According to an embodiment, the inks and the mixture are applied to the coating layer simultaneously with gravure cylinders. According to an embodiment, an ink and the mixture are mixed and simultaneously applied to the coating layer with gravure cylinders.

In an embodiment, a ketone or acetate is added to the mixture before application, preferably the ketone is butanone or 2-pentanone and the acetate is n-butyl acetate and preferably the ketone is added if the viscosity of the mixture, measured according to DIN EN ISO 2431, is 30″ or more. According to an embodiment, a ketone is added to the mixture before application, preferably the ketone is butanone and the ketone is added if the viscosity of the mixture, measured according to DIN EN ISO 2431, is 50″ or more. The viscosity of the mixture may increase slowly. According to an embodiment, butanone is added to keep the viscosity sufficiently low, preferably between 5 and 50″, more preferably between 10 and 40″, measured according to DIN EN ISO 2431. If the viscosity becomes too high, the adhesion to the first printing cylinder is less efficient and the coating layer on the substrate will not be printed as well. Because the ketone keeps the viscosity of the mixture, measured according to DIN EN ISO 2431, between 5 and 50″, the first printing cylinder will always apply the same amount of the mixture to the coating layer on the substrate. Without wishing to be bound by theory, the isocyanates can react with other components in the mixture, causing the viscosity to slowly increase after mixing the various components. Adding a ketone slows down these reactions. In an embodiment, the mixture is cooled. By cooling, the viscosity of the mixture, measured according to DIN EN ISO 2431, can easily be kept sufficiently low.

According to an embodiment, the coating layer is gelled with a coating system, the coating system comprising an applicator roller, a support roller and a metering roller. According to a further embodiment, the applicator roller is coupled to the metering roller in a first roller pair, for providing a predetermined amount of thermoplastic material on the applicator roller per unit area of the applicator roller; wherein the substrate layer is passed between a second roller pair consisting of the applicator roller and the support roller, and the amount of thermoplastic material provided on the applicator roller is thereby transferred to the substrate layer, the substrate layer being passed against the direction of rotation of the applicator roller between the applicator roller and the support roller.

According to an embodiment, the applicator roller rotates at an applicator roller speed in meters per minute and the support roller rotates at a support roller speed in meters per minute, preferably where the support roller determines the throughput speed of the substrate layer through the coating system, and the applicator roller speed and the support roller speed have a ratio between 1 and 2, preferably between 1.25 and 1.75 and more preferably between 1.4 and 1.6, and wherein the applicator roller speed is at least 60 meters per minute (mpm), preferably at least 80 mpm, and more preferably at least 100 mpm.

According to an embodiment, the vinyl layer is applied via a rolling technique, knife coating, screen printing, curtain or slot coating or calendering.

According to an embodiment, the top layer comprises a virucidal coating, inks and a protective intermediate layer. According to an embodiment, the virucidal coating is applied to a protective intermediate layer, the protective intermediate layer being on top of the inks. By using this protective intermediate layer, there is less discoloration and build-up on the rollers in the machine.

According to an embodiment, the metering roller rotates at a metering roller speed in meters per minute, wherein the ratio between the applicator roller speed and the metering roller speed is between 10 and 25, preferably between 12 and 20, and more preferably between 14 and 16.

In a fourth aspect, the invention relates to a flexible wall covering with virucidal coating manufactured by means of a method according to the third aspect. This flexible wall covering kills viruses and microorganisms that come into its vicinity quickly and for a long time.

One skilled in the art will note that a method according to the third aspect is preferably carried out for manufacturing a flexible wall covering according to the first aspect or the second aspect. Each feature described in this document, both above and below, can therefore relate to any of these four aspects of the present invention.

In the following, the invention is described by way of non-limiting examples or figures which illustrate the invention, and which are not intended or construed to limit the scope of the invention.

### DESCRIPTION OF THE FIGURES

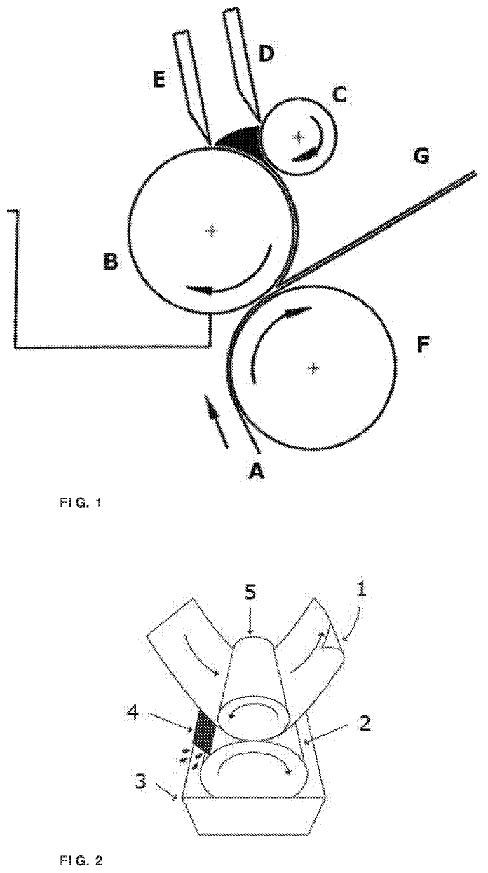

FIG. 1 shows a schematic representation of a coating process according to an embodiment of the present invention.

FIG. 1 describes the construction of a reverse roller coating system according to a possible embodiment of the invention. A substrate layer (A) is passed between an applicator roller (B) and a support roller (F). A metering roller (C) in conjunction with the applicator roller (B) and two blades or squeegees (D, E) provide a vinyl composition on the applicator roller. Next, applicator roller (B) deposits the vinyl composition onto the substrate layer (A), leading to the substrate layer with the coating layer (G) on top.

FIG. 2 shows a schematic representation of a printing process according to an embodiment of the present invention.

FIG. 2 describes the construction of a reverse roller printing system according to a possible embodiment of the invention. A substrate (1), for example paper, is placed between a first gravure cylinder (2) and a second gravure cylinder (5). The first gravure cylinder is also called the engraved cylinder because grooves were made in the surface. The first gravure cylinder (2) rotates in an ink reservoir (3). The ink reservoir contains a liquid comprising: inks and/or a mixture comprising an isocyanate and a methoxysilane. Part of the liquid present in the ink reservoir (3) will adhere to the first gravure cylinder (2). A squeegee or blade (4) is suitable for removing excess liquid from the surface of the first gravure cylinder (2) and draining it back into the ink reservoir (3). The substrate (1) comes into contact with the correct amount of liquid. The second gravure cylinder (5) presses the substrate against the first gravure cylinder (2). In this way, the substrate is printed on one side with ink(s) and/or a virucidal coating.

### EXAMPLES

The invention will now be further explained on the basis of the following example, without however being limited to this.

### Example 1

Example 1 concerns a comparative study between a virucidal coating applied to different surfaces.

The mixture, comprising a fluoropolymer, an isocyanate and a methoxysilane, was applied to stainless steel, glass and wallpaper. The mixture was sprayed onto all substrates. On wallpaper, the mixture was also applied with a printing process via a roller coating technique. The amount applied varied. Percent kill was measured according to ISO 21702.

For applied amounts greater than 3 g of dry mixture/m², both sprayed surfaces and the wallpaper treated with a printing process show good killing (Table 2). For quantities lower than 3 g/m², the kill rate has decreased for the sprayed surfaces. Surprisingly, a high kill rate is maintained for wallpaper treated with a printing process where less than 3 g/m² was applied.

TABLE 2
kill rate on different substrates, at different applied amounts.

| | Amount applied (g dry | |
|---|---|---|
| Substrate | mixture/m²)/method | Kill rate (%) |
| Stainless steel | 5.0/spraying | 100 |
| | 2.5/spraying | 80 |
| Glass | 5.0/spraying | 100 |
| | 2.3/spraying | 74 |
| Wallpaper | 5.0/printing process | 100 |
| | 2.8/printing process | 100 |
| | 3.7/spraying | 71 |

### Example 2

This example concerns a comparative study between wallpaper with or without a coating layer with vinyl composition.

The mixture, comprising a fluoropolymer, an isocyanate and a methoxysilane, was applied to wallpaper with or without a coating layer with vinyl composition. The vinyl composition comprises polyvinyl chloride (PVC), 88.5 w %; polyurethane (PU), 10 w %; red pigments, 0.5 w %; and 1 w % bentonite. Percent kill was measured according to ISO 21702.

If the coating layer with vinyl composition was applied to the wallpaper, a good kill was obtained for an applied amount of 5 or 2.8 g of dry mixture per m² with a printing process (Table 3). Without a coating layer, the kill percentage was lower.

TABLE 3
kill rate on wallpaper with or without
a coating layer with vinyl composition.

| | Amount applied (g dry | |
|---|---|---|
| Substrate | mixture/m²)/method | Kill rate (%) |
| Wallpaper with coating layer | 5.0/printing process | 100 |
| with vinyl composition | 2.8/printing process | 100 |
| | 3.7/spraying | 71 |
| Wallpaper without coating | 5.0/printing process | 97 |
| layer with vinyl composition | 2.8/printing process | 76 |
| | 3.7/spraying | 63 |

### Example 3

Example 3 concerns a comparative study between wallpaper with a vinyl layer and with a virucidal coating and a wallpaper with a vinyl layer and without a virucidal coating. The virucidal coating was applied in the form of a mixture comprising a fluoropolymer, an isocyanate and a methoxysilane.

Emission screening was done by a thermal extraction test. No emissions were detected that could be linked to the virucidal coating. There is also no evidence that the virucidal coating would have an inhibiting effect on the emission of VOCs from the vinyl layer. The virucidal coating also appeared to have no negative impact on the lightfastness of the wallpaper. This was tested using ISO 105B02:2014 method 2.

1. A flexible wall covering with a virucidal coating, comprising:
a substrate layer of a carrier material, the substrate layer comprising a nonwoven, and the substrate layer having a surface density of at least 50 g/m²;
a coating layer on the carrier material, the coating layer comprising a vinyl composition; and
a top layer on the coating layer, the top layer being applied via a printing process; characterized in that the top layer comprises a the virucidal coating and optionally inks, wherein the virucidal coating comprises a mixture of an isocyanate and a methoxysilane.

2. The flexible wall covering with the virucidal coating according to claim 1, characterized in that the top layer comprises 0.5-20 g of the virucidal coating per m².

3. The flexible wall covering with the virucidal coating according to claim 1, characterized in that the vinyl composition comprises:
polyvinyl chloride (PVC); polyurethane (PU); at least one pigment; and one or more fillers, wherein the vinyl composition comprises 1-50 weight percent fillers.

4. A flexible wall covering with a virucidal coating, comprising:
a substrate layer of carrier material, the substrate layer comprising and a nonwoven, and the substrate layer having a coefficient of friction of maximally 0.4;
a top layer on the substrate layer, the top layer being applied via a printing process; characterized in that the top layer comprises the virucidal coating and optionally inks, wherein the virucidal coating comprises a mixture of an isocyanate, a methoxysilane.

5. A method for manufacturing a flexible wall covering with a virucidal coating, comprising:
providing a substrate layer of a carrier material, the substrate layer comprising a nonwoven, and the substrate layer having a surface density of at least 50 g/m²;
applying a coating layer to the substrate layer;
applying the at least one top layer on the coating layer through a printing process;
drying at least one top layer; and
optionally providing a relief by embossing in the coating layer,
characterized in that the at least one top layer comprises the virucidal coating and optionally inks, and wherein the virucidal coating is obtained by mixing an isocyanate, a methoxysilane and optionally a fluoropolymer.

6. The method according to claim 5, characterized in that 1-15 w % fluoropolymer, 1-10 w % isocyanate and 0.2-15 w % methoxysilane are mixed with at least one solvent to obtain the virucidal coating.

7. The method according to claim 5, characterized in that the printing process for applying at least one top layer comprises a roller coating technique using a first and a second gravure cylinder.

8. The method according to claim 7, characterized in that a side of the substrate layer where the coating layer is provided lies against the first gravure cylinder and in which the second gravure cylinder provides a pressure on the substrate layer and the provided coating layer between 0.2 and 2.5 bar.

9. The method according to claim 7, characterized in that the virucidal coating is applied to 1000-8000 rectangular cells per cm² surface of the first gravure cylinder, the rectangular cells being formed by grooves that are grid-shaped in the surface of the first gravure cylinder.

10. The method according to claim 9, characterized in that the distance between the grooves running in the same direction is 50-500 μm, and the grooves are 20-100 μm deep.

11. The method according to claim 5, characterized in that the at least one top layer is dried in an oven with IR lamps with a total electrical power of 50-500 kW for 1-100 min.

12. The method according to claim 11, characterized in that the substrate layer is passed through the oven at a speed between 50 meters per minute (mpm) and 100 mpm.

13. The method according to claim 5, characterized in that a ketone or acetate is added before application.

14. The method according to claim 5, characterized in that the coating layer is provided with a minimum surface density of 100 g/m².

15. A flexible wall covering with a virucidal coating manufactured by means of a method according to claim 5.
